(19) United States
(12) Patent Application Publication
(10) Pub. No.: US 2015/0223447 A1
(43) Pub. Date: Aug. 13, 2015

(54) REACTIONARY TURKEY TARGET

(71) Applicant: Thomas J. Miller, Carmel, IN (US)

(72) Inventor: Thomas J. Miller, Carmel, IN (US)

(21) Appl. No.: 14/621,375

(22) Filed: Feb. 12, 2015

Related U.S. Application Data
(60) Provisional application No. 61/938,734, filed on Feb. 12, 2014.

(51) Int. Cl. A01M 31/06; A01M 31/00

(52) U.S. Cl. CPC A01M 31/06; A01M 31/00

(57) ABSTRACT

A kit for a reactionary turkey target includes a first component layer, a second component layer, means for attaching the first component layer to the second component layer, and a pair of rods. The first component layer has a profile shape corresponding to a head of game animal. The second component layer has a profile shape corresponding to a body of a game animal. The pair of rods is configured to be attached to the second component layer, for supporting the assembled reactionary turkey target in an upright position.

### CROSS-REFERENCE TO RELATED APPLICATIONS

This application claims the benefit of U.S. Provisional Application No. 61/938,734 filed on Feb. 12, 2014. The entire disclosure of the above application is hereby incorporated herein by reference.

### FIELD

The present disclosure relates to hunting targets and decoys and, more specifically, to a kit for a combination target and decoy that may be used for shooting practice, patterning a shotgun, determining accuracy with a shotgun, and hunting.

### BACKGROUND

Hunters commonly pattern their shotguns prior to hunting season. This patterning is commonly performed using paper. This allows hunters to see how the shot pattern disperses when the gun and game load are fired from several distances.

Originally, patterning was accomplished with nothing more than blank paper. Bullseye targets and related advancements were subsequently developed to more clearly indicate point of impact. Even later, images of game animals were printed on paper, allowing hunters to “practice like you hunt”. Paper with images of game animals is often a standard patterning tool for the modern shotgun hunter.

To further facilitate shooting practice, free standing targets have also been used. In U.S. Pat. No. 7,712,743 to Miller, a target for practicing hunting or for measuring the accuracy or pattern of a shotgun is described. The target includes a target stand that may be supported in an upright position. A frangible head and neck target can then be attached to the target stand for purposes of the shooting practice.

There is a continuing need for a kit and related reactionary target having a life-like and life-size target for shotgun practice, in which there is a head and neck region serving as the target, and a game animal-shaped body serving as the target stand. Desirably, the kit and reactionary target may be used for both target practice and as a decoy for hunting.

### SUMMARY

In concordance with the instant disclosure, kit and related reactionary target having a life-like and life-size target for shotgun practice, in which there is a head and neck region serving as the target, and a game animal-shaped body, serving as the target stand, and which may be used for both target practice and as a decoy for hunting, is surprisingly discovered.

In one embodiment, a kit for a combination reactionary target and decoy includes a first component layer, a second component layer, means for attaching the first component layer to the second component layer, and a pair of rods. The first component layer has a profile shape corresponding to a head of a game animal. The second component layer has a profile shape corresponding to a body of the game animal. The pair of rods is configured to be attached to the second component layer, for supporting the assembled combination reactionary target and decoy in an upright position.

In a further embodiment, a method for making a combination reactionary target and decoy includes the steps of providing a first component layer having a profile shape corresponding to a head of the game animal, and providing a second component layer having a profile shape corresponding to a body of the game animal. The first component layer is then attached to the second component layer. The assembled combination reactionary target and decoy is then supported in an upright position for use in target practice or as a decoy.

In another embodiment, a combination reactionary target and decoy includes a first component layer having a profile shape corresponding to a head of a game anima, and a second component layer having a profile shape corresponding to a body of the game animal and attached to the first component layer. A pair of rods is attached to the second component layer for supporting the assembled combination reactionary target and decoy in an upright position.

In a particular embodiment, the target kit includes at least one (1) turkey head, one (1) turkey body, a plurality of double-sided adhesive strips or other means of attaching the head to the body, and two (2) metal rods. It is also envisioned that the turkey kit may require (1) turkey “tail fan”.

The turkey head(s) and body are comprised of cardboard, paper, or some other type of material that allows for the pattern of the shotgun pellets to be revealed on the head/neck target after a shot is made. The head and neck have the life-like appearance of a turkey's head and neck. The body (stand) has the life-like appearance of a turkey body.

When the head and neck are attached to the body by means of the adhesive strips or other connecting material, the comprehensive target has the complete, life-like appearance of a wild turkey. The metal rods insert into the target and serve as the turkey “legs.”

Where the target is made of cardboard, the metal rods slide up the fluting provided by the cardboard corrugation. Where the target is made of paper or some other material, special channels or means of connection are provided to allow the rods to hold the stand upright. These rods, once inserted into or connected to the turkey target, go into the ground or some other surface, allowing the target to stand upright and be shot.

The turkey target may be two-dimensional, with either one-side or both sides of the target printed with the life-like image of the turkey, or may be three-dimensional to allow for the turkey's tail to appear “fanned” in order to replicate the appearance of a strutting turkey. The head and neck targets are intended to be shot once and then evaluated for shot accuracy, pattern, and downrange power, though the potential of limited damage to the target through a misplaced shot or long-distance shooting may provide for repeated use.

The turkey body is intended for repeated use up to the number of target heads provided in the kit but could be substantially damaged and rendered non-functional by a misplaced shot. The turkey head and neck, while attached to the body with adhesive stickers or other means of attachment, is intended to “react” to shots—particularly those at shorter distances—by breaking away from the body. It may also partially detach and bend backwards along a shallow cut that is built into the head/neck target to provide for this reaction. It may also “pivot” on those points that remain connected to the body, providing another type of noticeable “reaction.” These reactions provide immediate feedback about shot placement, accuracy, and downrange power, and add an element of excitement to training for turkey hunting.

Additionally, the life-like size and appearance of the target mentally prepares turkey hunters for how a live turkey will appear in the wild, at various distances, so that the hunter will make good decisions about when to make a lethal and accurate shot. It should further be appreciated that the life-like size and appearance of the target permits it to also be effectively used as a decoy while hunting.

### DRAWINGS

The above, as well as other advantages of the present disclosure, will become readily apparent to those skilled in the art from the following detailed description, particularly when considered in the light of the drawings described hereafter.

FIG. 1 is a front elevational view of a kit for a combination reactionary target and decoy according to one embodiment of the present disclosure, the kit shown disassembled;

FIG. 2 is a front elevational view of the combination reactionary target and decoy shown in FIG. 1, the combination reactionary target and decoy shown partly assembled with the head portion detached from the main body portion;

FIG. 3 is a front elevational view of the combination reactionary target and decoy shown in FIGS. 1-2, the combination reactionary target and decoy shown fully assembled with the head portion attached to the main body portion;

FIG. 4 is a rear elevational view of the combination reactionary target and decoy shown in FIGS. 1-3, the combination reactionary target and decoy shown fully assembled with the head portion attached to the main body portion; and

FIG. 5 is a bottom elevational view of the main body of the combination reactionary target and decoy shown in FIGS. 3-4, illustrating the corrugations that receive rods for supporting the combination reactionary target and decoy in operation.

### DETAILED DESCRIPTION

The following description is merely exemplary in nature and is not intended to limit the present disclosure, application, or uses. It should also be understood that throughout the drawings, corresponding reference numerals indicate like or corresponding parts and features. In respect of the methods disclosed, the order of the steps presented is exemplary in nature, and thus, is not necessary or critical.

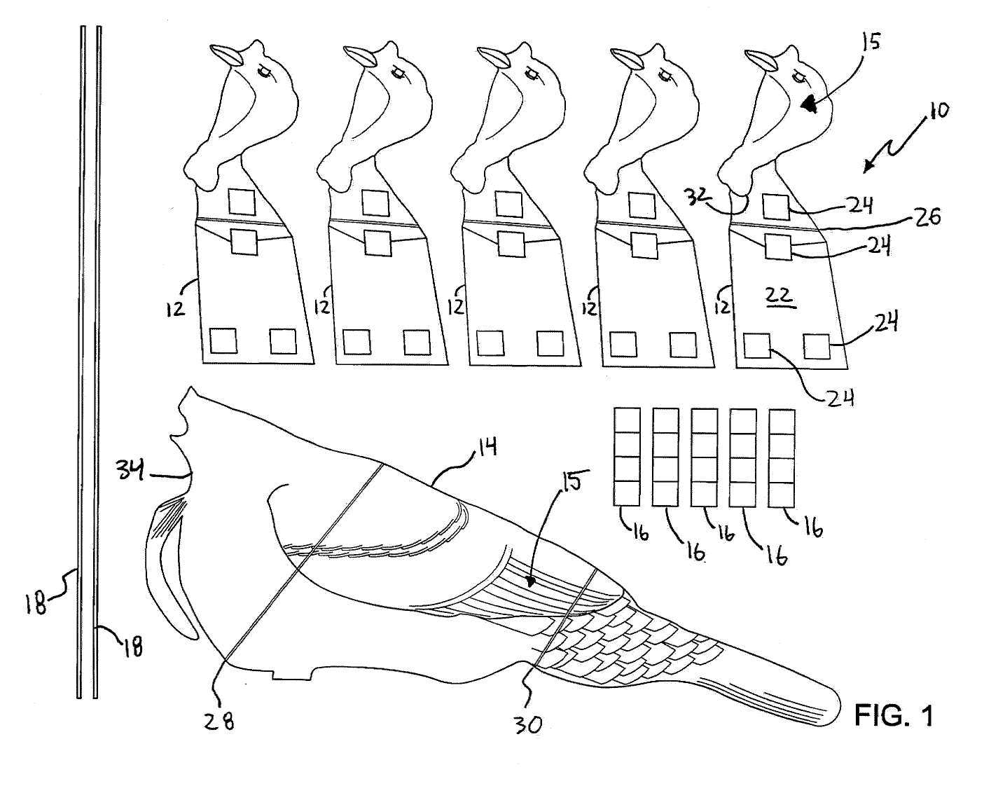

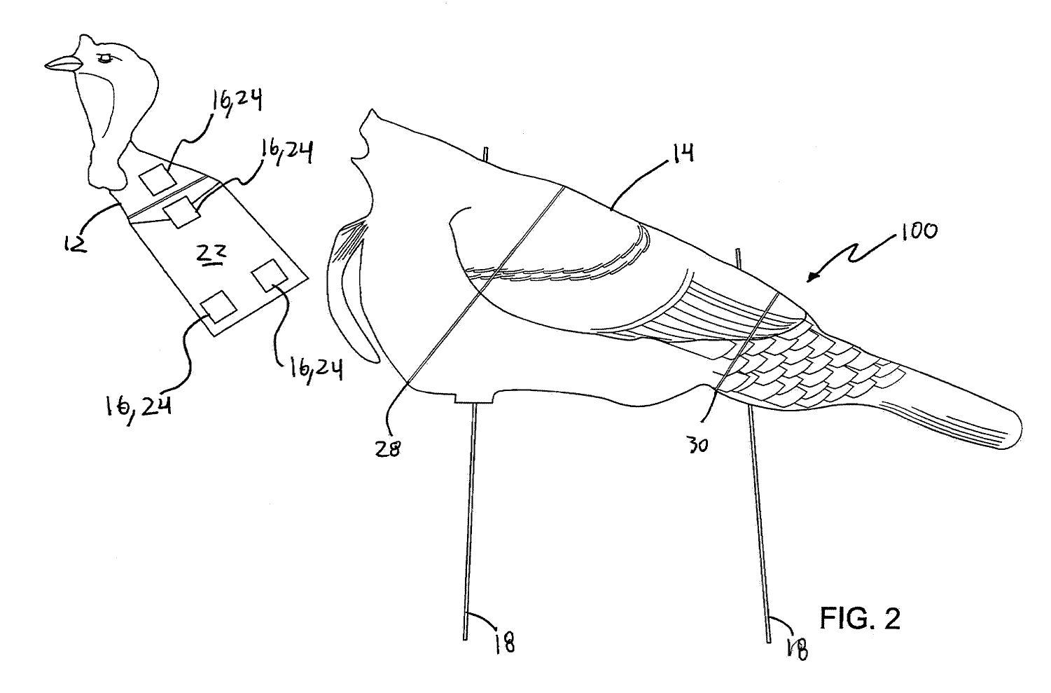

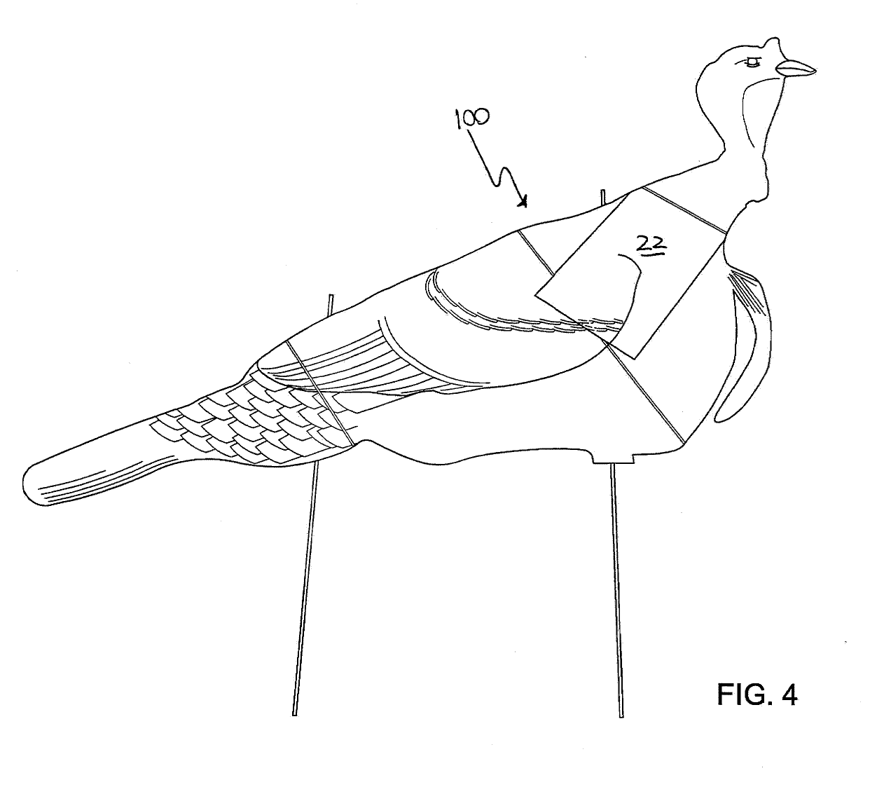

In FIGS. 1-5, a kit 10 and a related combination reactionary target and decoy 100 are illustrated. Although the kit 10 and the combination reactionary target and decoy 100 are described primarily herein with respect to a turkey as the game animal used for the overall profile shape, it should be understood that any other type of game animal such as a goose, a duck, a deer, etc., may also be used within the scope of the present disclosure.

Referring to FIG. 1, the kit 10 includes a first component layer 12 or head portion and a second component layer 14 or main body portion. The first component layer 12 has a profile shape corresponding generally to a head of a game animal. The second component layer 14 has a profile shape corresponding generally to a body of the game animal.

In particular embodiments, at least one major surface of each of the first component layer 12 and the second component layer 14 also has a realistic image 15 of the game animal represented by the combination reactionary target and decoy 100 formed by the kit 10. The realistic image 15 may be in the form of a printing or laminated picture on the major surface. Other suitable means for placing the realistic image of the game animal on each of the first component layer 12 and the second component layer 14 may also be used, as desired.

The kit 10 also includes means for attaching 16 the first component layer 12 to the second component layer 14. In one example, the means for attaching are double-sided adhesive strips or tape. The means for attaching 16 may include double-sided mounting foam tape, for example. The means for attaching 16 desirably provide for a means of easily removing the first component layer 12 from the second component layer 14 after use, for example, after the first component layer 12 has been shot by a shotgun during target practice.

The kit 10 further includes a pair of rods 18. The rods 18 are configured to be attached to the second component layer 14, for supporting the assembled combination reactionary target and decoy 100 in an upright position. Although rods 18 are described primarily herein as the means for supporting the combination reactionary target and decoy 100 in the upright position, one of ordinary skill in the art may select other suitable means such as molded plastic stands or leaning cardboard supports, as desired.

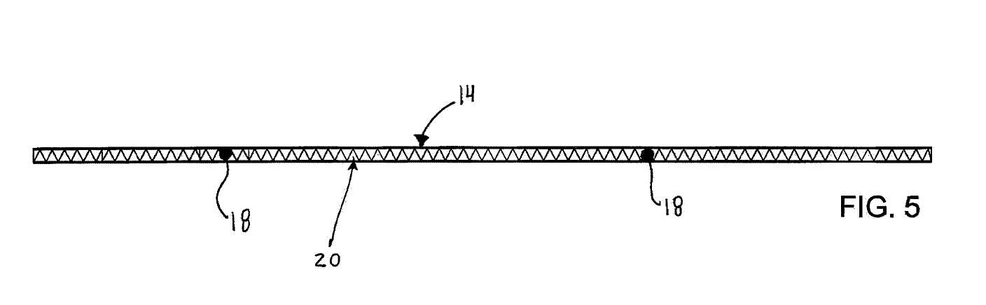

It should be appreciated that the first component layer 12 and the second component layer 14 may advantageously be formed from a recyclable and biodegradable material such as cardboard. Where cardboard is used, it should likewise be appreciated that the cardboard may have corrugations 20, for example, as shown in FIG. 5. For the second component layer 14, in particular, the corrugations 20 may provide apertures for receiving the rods 18, which permits the rods to support the combination reactionary target and decoy 100. Other suitable means, such as adhesives or mechanical fasteners, for attaching the rods 18 to the second component layer 14 may also be used within the scope of the present disclosure.

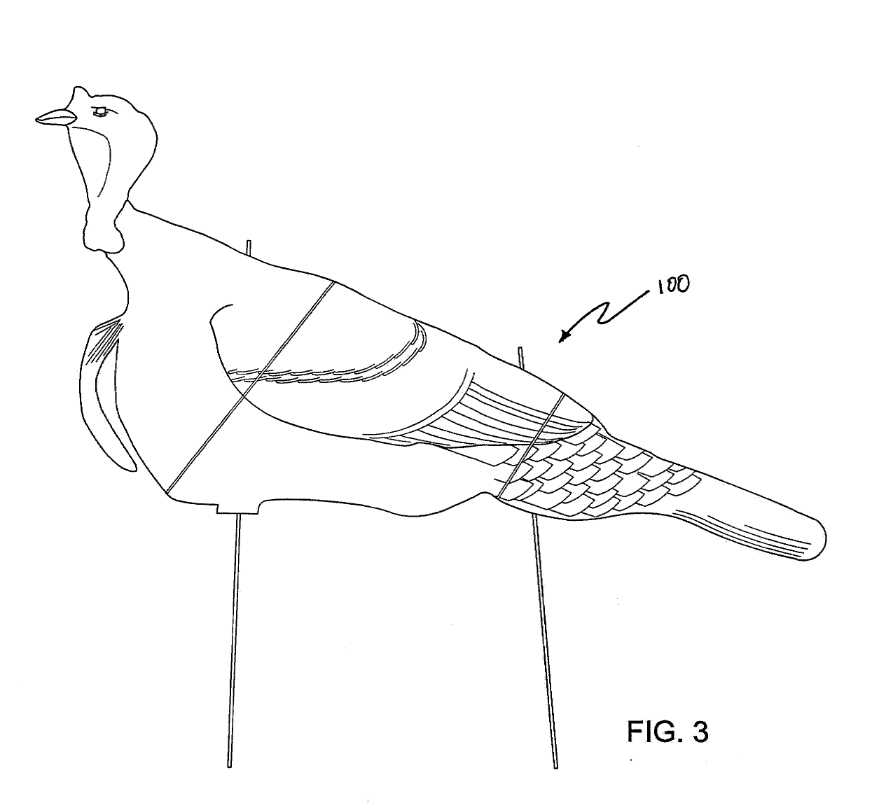

With reference to FIGS. 1 and 3, it should be appreciated that the first component layer 12 has an attachment portion 22 configured for attaching the first component layer 12 to the second component layer 14. For example, the attachment portion 22 may be in the form of an elongate rectangular section adjacent and attached to the profile shape of the head of the game animal. The attachment portion 22 may further have a plurality of markings 24 formed thereon. The markings 24 may identify optimal locations to dispose the means for attaching 16 the first component layer 12 to the second component layer 14.

With renewed reference to FIG. 1, the first component layer 12 may further have a shallow cut 26 formed therein. The shallow cut 26 may extend from one side of the first component layer 12 to another side of the first component layer 12, for example. The shallow cut 26 permit a reactionary bending of the first component layer 12 along the shallow cut 26. For example, if the first component layer 12 were to be hit by shot during target practice, the first component layer 12 will bend, and permit a visual recognition on the part of the person performing the target practice that the first component layer 12 was hit.

The second component layer 14 may likewise have a first shallow cut 28 and a second shallow cut 30. The first shallow cut 28 and the second shallow cut 30 are spaced apart and formed in the second component layer 14 from one side of the second component layer 14 to another side of the second component layer 14. The first shallow cut 28 and the second shallow cut 30 permit a folding of the second component layer 14 along the first shallow cut 28 and the second shallow cut 30 to a folded (trifold) position. The folded position facilitates a packaging of the second component layer 14 in a compact kit package, and also facilitates an easier transport of the second component layer 14 into the field for assembly of the combination reactionary target and decoy 100 for target practice or hunting.

Additionally, the first component layer 12 may have an alignment marking 32 printed on a major surface of the first component layer 12. The second component layer 14 may have a mating alignment recess 34 formed in a peripheral edge of the second component layer 14. The alignment marking 32 and the alignment recess 34 are configured to be visually aligned to confirm a correct placement of the first component layer 12 with the second component layer 14 for attachment upon assembly of from the kit 10.

It should be appreciated that, upon attachment of the first component layer 12 with the second component layer 14, a profile shape of the game animal is provided. For example, the game animal may be one of a turkey, a goose, a duck, and a deer, although other types of game animal shapes may also be employed. The game animal profile shape advantageously enhances the target practice experience. The game animal profile shape is also sufficiently realistic to allow the combination reactionary target and decoy 100 to be used as a decoy while hunting.

While certain representative embodiments and details have been shown for purposes of illustrating the invention, it will be apparent to those skilled in the art that various changes may be made without departing from the scope of the disclosure, which is further described in the following appended claims.

What is claimed is:

1. A kit for a combination reactionary target and decoy, comprising:
a first component layer having a profile shape corresponding to a head of a game animal;
a second component layer having a profile shape corresponding to a body of the game animal;
means for attaching the first component layer to the second component layer; and
a pair of rods configured to be attached to the second component layer, for supporting the assembled combination reactionary target and decoy in an upright position.

2. The kit of claim 1, wherein the second component layer has a plurality of apertures arranged around a peripheral edge of the profile shape and configured to receive the rods.

3. The kit of claim 2, wherein the second component layer is formed from corrugated cardboard and the plurality of apertures is defined by the corrugations of the cardboard.

4. The kit of claim 1, wherein the first component layer has an attachment portion configured for attaching the first component layer to the second component layer.

5. The kit of claim 4, wherein the attachment portion has a plurality of markings identifying locations to dispose the means for attaching the first component layer to the second component layer.

6. The kit of claim 1, wherein each of the first component layer and the second component layer has a major surface with a printed image of the game animal.

7. The kit of claim 1, wherein the first component layer has a shallow cut formed therein from one side of the first component layer to another side of the first component layer, the shallow cut permitting a bending of the first component layer along the shallow cut.

8. The kit of claim 1, wherein the second component layer has a first shallow cut and a second shallow cut spaced apart and formed therein from one side of the second component layer to another side of the second component layer, the first shallow cut and the second shallow cut permitting a folding of the second component layer along the first shallow cut and the second shallow cut to a folded position.

9. The kit of claim 1, wherein the means for attaching the first component layer to the second component layer includes double sided adhesive strips.

10. The kit of claim 1, wherein the first component layer has an alignment marking printed on a major surface of the first component layer, and the second component layer has an alignment recess formed in a peripheral edge of the second component layer, the alignment marking and the alignment recess configured to be visually aligned to confirm a correct placement of the first component layer with the second component layer for attachment.

11. The kit of claim 1, wherein attachment of the first component layer with the second component layer provides a profile shape of a game animal.

12. The kit of claim 11, wherein the game animal is one of a turkey, a goose, a duck, and a deer.

13. The kit of claim 12, wherein the game animal is the turkey.

14. The kit of claim 1, further comprising a plurality of the first component layer.

15. A method for making a combination reactionary target and decoy, the method comprising the steps of:
providing a first component layer having a profile shape corresponding to a head of the game animal;
providing a second component layer having a profile shape corresponding to a body of the game animal;
attaching the first component layer to the second component layer; and
supporting the assembled combination reactionary target and decoy in an upright position.

16. A combination reactionary target and decoy, comprising:
a first component layer having a profile shape corresponding to a head of a game animal;
a second component layer having a profile shape corresponding to a body of the game animal and attached to the first component layer; and
a pair of rods attached to the second component layer for supporting the assembled combination reactionary target and decoy in an upright position.
